(19) United States
(12) Patent Application Publication
(10) Pub. No.: US 2007/0199892 A1
(43) Pub. Date: Aug. 30, 2007

(54) Method for producing hollow fiber membranes

(75) Inventors: Klaus-Viktor Peinemann, Geesthacht (DE); Ricardo de Olivera Mascarenhas, Bosque (BR); Sonia Verissimo, Carvalhal Benfeito (PT); Carsten Blicke, Wurselen (DE)

Correspondence Address: MICHAUD-DUFFY GROUP LLP, 306 INDUSTRIAL PARK ROAD, SUITE 206, MIDDLETOWN, CT, 06457, US

(73) Assignee: GKSS-Forschungszentrum Geesthacht GmbH, Geesthacht (DE)

(21) Appl. No.: 11/717,448

(22) Filed: Mar. 13, 2007

Related U.S. Application Data
(63) Continuation of application No. PCT/EP05/09404, filed on Jan. 9, 2005.

(30) Foreign Application Priority Data
Sep. 20, 2004 (DE) 10 2004 045 848.0

(51) Int. Cl. B01D 69/00

(52) U.S. Cl. 210/500.23; 210/500.41; 210/500.42; 210/500.43; 264/41

(57) ABSTRACT

The invention relates to a method for producing hollow fiber membranes having an interior separation layer, said separation layer being produced according to the phase interface polymerization method. According to the inventive method, once the hollow fibers are produced, a) their interior is flushed with an amine solution, b) said amine solution is replaced by an agent that is inert relative to the amine solution, c) and the inert agent in the interior is displaced by an acid chloride solution.

### CROSS-REFERENCE TO RELATED APPLICATIONS

This application is a continuation of and claims priority to International Patent Application No. PCT/EP2005/009404 filed on Sep. 1, 2005, which claims priority to German Patent Application No. 10 2004 045 848.0 filed on Sep. 20, 2004, subject matter of these patent documents is incorporated by reference herein in its entirety.

### FIELD OF THE INVENTION

The invention concerns a method for making hollow fiber membranes with internally lying separation layers wherein the separation layer is made according to the phase interface surface polymerization method.

### BACKGROUND OF THE INVENTION

The use of flat or hollow fiber membranes for widely different separation purposes in the separation of liquid and gaseous media is well known to the person skilled in the art, with such membranes being used in many areas of application, especially in benzene vapor recovery, the extraction of rare gases from natural gas mixtures, in seawater desalination, and also in the field of industrial or drinking water recovery from waste water sumps and the like. The previously given list of application fields for the membranes is not at all complete and should here be taken to be only indicative of the wideness of their field of application.

The production or making of the actual separation layer of membranes can be done in very different ways and is usually correlated to the material separating method to be carried out by the membrane. For example, membranes which are to work or perform according to the principle of reverse osmosis or nano filtration are provided with a separation active layer which often is made according to the method of so-called phase interface polymerization. In this case a membrane which right after the formation of the membrane body does not yet have any separation properties, is then saturated with a thinned aqueous amine solution. Then the surplus solution is removed from the upper surface of the membrane body, and following this the membrane body is overcoated with an acid chloride solution in a hydrocarbon atmosphere or environment. By this method, at the boundary surface of the membrane, there is thereby formed a thinned polyamide layer, which represents the actual membrane.

A problem that occurs with this way of making a membrane is that small drops of the amine solution remain on the upper surface of the actual membrane which was formed by the solution. These drops lead to defect spots in the polyamide layer. In the case of the making of flat membranes this problem can be simply solved by a mechanical removal of the drops, for example with the help of a rubber roll moved over the actual membrane.

It is self-evident that hollow fiber membranes, which are to have their actual separation layers at their interior surfaces, cannot be freed of the droplets by the methods known for removing them from flat membranes, since the hollow fibers usually have a diameter of less than 1 mm.

The result is that previously, no fault free internally layered hollow fiber membranes layered according to the principle of phase interface polymerization could be made.

Indeed, from U.S. Pat. No. 4,772,391 a formation of an internal layer, which forms the separation active layer, for the use of a hollow fiber membrane according to the reverse osmosis method is known. However, it has been shown that this method delivers insufficient separation results. In the known method an amine solution is sucked into the hollow fiber body and after a short delay time the amine solution is sucked out and the same process is repeated with an acid chloride solution and thereafter, as the case may or may not be, after the removal of the aqueous solution it is flushed with an air stream. It has been shown that with the mere draining of the aqueous solution it cannot be assured that no drops remain in the interior space on the membrane surface. These remaining drops cannot be removed by short flushing with a gas, for example air or nitrogen. Moreover, if the flushing is carried out too long it dries the separation active layer of the hollow fiber membrane which at least leads to poor separation results, and as a rule to a useless condition of the membrane.

It is therefore the object of the present invention to provide a method by means of which hollow fiber membranes can be made to have an interior separation active layer made by means of the phase interface polymerization method with the method being simple to carry out with reliable results.

### SUMMARY OF THE INVENTION

This object is solved in accordance with the invention in that the hollow fibers after their production:
a. are flushed in their interior space with an amine solution,
b. then the amine solution is superseded by an agent inert with respect to the amine solution,
c. and then the inert agent in the inner space is displaced by an acid chloride solution.

An advantage of the present invention is that by means of the proposed method the droplets appearing on the coating of the inner surfaces of the hollow fibers which heretofore could not be removed from the interior space are on the whole avoided. It is a further advantage in that in comparison to the known methods, the method according to the invention does not dry out the interior surface of the membrane.

### DETAILED DESCRIPTION OF THE PREFERRED EMBODIMENTS OF THE PRESENT INVENTION

The present invention is directed to a method for making hollow fiber membranes having an internal separation layer created by phase interface polymerization. Once at least one, and preferably, more than one hollow fiber membrane is created, an interior space defined by the hollow fiber membrane is flushed with an amine solution. The amine solution is then replaced with a fluid that is inert relative to the particular amine solution. Following this step, the inert fluid is replaced with an acid chloride solution.

According to a preferred embodiment of the method of the present invention, the inert agent is not a water soluble agent, with the inert agent being basically a liquid. Actually the inert agent pushes the amine solution out of the hollow fibers so that it does not lead to the disadvantageous formation of droplets. Accordingly, the phase interface polymerization takes places in a fault free manner.

The non-water soluble inert agent can for example be a fluorinated carbohydrate. The amine of the amine solution can be chosen in dependence on the given separating problem, in dependence on the material forming the hollow fibers, and in dependence on the separating mechanisms with which the coated hollow fiber membranes are to be used, for example reverse osmosis or nano filtration. It is for example possibly advantageous to use phenylendiamin as the amine of the amine solution.

As the acid chloride of the acid chloride solution trimesoylchloride can be advantageously used.

Since the hollow fibers themselves are actually only carriers for the real separation membrane, which is formed on the inner surfaces of the hollow fibers, it is advantageous to form the hollow fibers such that they themselves have a porous structure which does not take part in the actual material separation process which is to be carried out by the hollow fiber membrane.

The hollow fiber forming material is preferably a polymer, with various suitable polymers being able to be of use, and with the selected polymer having to be in tune with the material separation intended to be made by the hollow fiber membrane. The polymer can for example be polysulfon, polyethersulfon, polyphenylensulfon, polyetherimid or polyacrylnitril, with this list of polymers being only exemplary and not exhaustive.

By way of the following four examples for the making of hollow fiber membranes, the present invention can be comprehended in more detail. The hollow fiber membranes of the invention used in the four examples serve for water desalination.

The examples are:

### EXAMPLE 1

A material separation module contains five polyetherimid hollow fiber membranes with an inner diameter of 0.64 mm which are coated with a thin polyamide layer or in the inner space of which a thin polyamide layer is formed by interface polymerization. First an aqueous 1.3% m-phenylendiamin solution is conducted into the hollow space. After thirty seconds a pure n-hexane is brought into or sucked into the inner space whereby the m-phenylendiamin solution is displaced, and subsequently a 0.8% trimesoylchrloride solution in hexane is pumped through the inner space. The trimesoylchrloride solution is removed after six seconds, under pressurized nitrogen, which is conducted through the inner space of the hollow fibers for 45 seconds. The hollow fiber membrane is flushed for a short time in methanol in order to remove the remainder of the m-phenylendiamin and is then flushed in water.

### EXAMPLE 2

The hollow fiber membranes, which were made in accordance with Example 1, were used in a reverse osmosis method at 10 bar for the desalination of 3000 ppm common cooking salt solution. The restraining ability with reference to the salt and the flow are given in Table 1.

TABLE 1

| Module Nr. | Salt restraining ability % | Flow Lm²h⁻¹bar⁻¹ |
|---|---|---|
| 1 | 98.1 | 1.4 |
| 2 | 97.5 | 1.5 |
| 3 | 99.2 | 1.8 |
| 4 | 97.6 | 1.4 |
| 5 | 98.3 | 2.2 |
| 6 | 97.0 | 2.6 |

### EXAMPLE 3

Polyetheramide hollow fiber membranes with an inner diameter of 0.74 mm were coated on the inner sides of the hollow fibers with a thin polyamid layer. The thin layer was formed by the continuous through put of a reactive fluid of c-hexane and water according to the following criteria or parameters. An aqueous solution of m-phenylendiamin (5 Wt. %, 1.5 min), c-Hexane (pure), an organic solution of trimesoylchloride in c-hexane (0.13%, 2 min) and water (pure, 2 min). The hollow fibers were then dried and a module including ten hollow fiber membranes was made. The hollow fiber membranes were then later again washed with 40 volume % methanol in water whereupon their usefulness for a material separation according to the reverse osmosis principle at 10 bar and a 3000 ppm common cooking salt solution was investigated or evaluated. The salt restraining ability and the flows are given in Table 2.

TABLE 2

| | | Salt restraining | |
|---|---|---|---|
| Module Nr. | Time c-Hexane sec. | ability % | Flow Lm²h⁻¹bar⁻¹ |
| 7 | 0 | 10 | 2.6 |
| 8 | 10 | 99.2 | 0.57 |
| 9 | 20 | 99.1 | 0.58 |
| 10 | 30 | 99.0 | 0.57 |
| 11 | 60 | 99.4 | 0.53 |
| 12 | 90 | 98.4 | 0.58 |
| 13 | 120 | 98.3 | 0.11 |

### EXAMPLE 4

Polyetheramid hollow fiber membranes with an inner diameter of 0.74 mm were assembled in an eight hollow fiber membranes including module. The making of these hollow fiber membranes differs from that of Example 3 in two points. The solutions were pushed solely through the hollow space of the hollow fibers and then left in the hollow space, and at the same time c-hexane was conducted into the hollow space and left there for one minute. The module was then left overnight in water, and then its suitability for a material separation respect to a 3000 ppm common cooking salt solution at 10 bar was investigated. The salt restraining ability and the flows are given in Table 3.

TABLE 3

| Module Nr. | Salt restraining ability % | Flow Lm²h⁻¹bar⁻¹ |
|---|---|---|
| 14 | 99.4 | 2.42 |
| 15 | 99.5 | 2.39 |
| 16 | 99.4 | 2.37 |
| 17 | 99.3 | 2.38 |
| 18 | 98.2 | 2.37 |
| 19 | 99.3 | 1.99 |
| 20 | 99.4 | 1.70 |

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for making hollow fiber membranes, the method comprising the steps of:
creating at least one hollow fiber membrane having an internal separation layer, the internal separation layer being created by phase interface polymerization;
flushing an interior space defined by the hollow fiber membrane with an amine solution;
replacing the amine solution with a fluid, the fluid being inert relative to the amine solution; and
displacing the inert fluid with an acid chloride solution.

2. The method according to claim 1, wherein the inert fluid is water insoluble.

3. The method according to claim 2, wherein the water insoluble inert fluid is a hydrocarbon.

4. The method according to claim 3, wherein the water insoluble inert fluid is a fluorinated hydrocarbon.

5. The method according to claim 1, wherein the amine of the amine solution is phenylendiamin.

6. The method according to claim 1, wherein the acid chloride of the acid chloride solution is trimesoylchloride.

7. The method according to claim 1, wherein the hollow fibers themselves have a porous structure.

8. The method according to claim 1, wherein the hollow fiber forming material is a polymer.

9. The method according to claim 8, wherein the polymer is one of polysulfon, polyethersulfon, polyphenylensulfon, polyetherimid and polyacrylnitril.

10. The method according to claim 2, wherein the amine of the amine solution is phenylendiamin.

11. The method according to claim 2, wherein the acid chloride of the acid chloride solution is trimesoylchloride.

12. The method according to claim 5, wherein the acid chloride of the acid chloride solution is trimesoylchloride.

13. The method according to claim 10, wherein the acid chloride of the acid chloride solution is trimesoylchloride.
